(19) United States
(12) Patent Application Publication
(10) Pub. No.: US 2024/0263935 A1
(43) Pub. Date: Aug. 8, 2024

(54) ANGLE DETECTION METHOD AND ANGLE DETECTION DEVICE

(71) Applicant: NIDEC CORPORATION, Kyoto (JP)

(72) Inventors: Toru KITANOYA, Kyoto (JP); Shota ISHIGAMI, Kyoto (JP)

(21) Appl. No.: 18/565,490

(22) PCT Filed: Mar. 10, 2022
(86) PCT No.: PCT/JP2022/010669

§ 371 Date: Nov. 29, 2023

(30) Foreign Application Priority Data
May 31, 2021 (JP) 2021-090904

(51) Int. Cl. G01B 7/30; G01D 5/14

(52) U.S. Cl. CPC G01B 7/30; G01D 5/145

(57) ABSTRACT

An angle detection device includes: three magnetic sensors detecting a change in magnetic flux due to rotation of a rotation shaft; and a signal processor that acquires sensor signals, generates a linear function θ(Δx) representing a straight line connecting adjacent intersection and zero-cross points, searches for a point where an error between a mechanical angle θ calculated based on the linear function θ(Δx) and a mechanical angle θe acquired from an encoder becomes a maximum value as a maximum error point, calculates a curve based on an origin, a vertex, and a control point, corrects the mechanical angle θ based on the curve, acquires a maximum error between the corrected mechanical angle θ and the mechanical angle θe, and after the value of Δx of the control point is changed in a direction in which the maximum error decreases, returns to the fifth process a predetermined number of times.

### CROSS-REFERENCE TO RELATED APPLICATIONS

This is the U.S. national stage of application No. PCT/JP2022/010669, filed on Mar. 10, 2022, and priority under 35 U.S.C. § 119(a) and 35 U.S.C. § 365(b) is claimed from Japanese Patent Application No. 2021-090904, filed on May 31, 2021.

### FIELD OF THE INVENTION

The present invention relates to an angle detection method and an angle detection device.

### BACKGROUND

Conventionally, a configuration including an absolute angle position sensor such as an optical encoder and a resolver is known as a motor capable of accurately controlling a rotational position. However, the absolute angle position sensor is large in size and high in cost. Therefore, conventionally, there is a position estimation method of estimating a rotational position of a motor using three inexpensive and small magnetic sensors without using an absolute angle position sensor.

### SUMMARY

In the conventional position estimation method, the mechanical angle of the rotation shaft can be estimated with high accuracy using three inexpensive and small magnetic sensors, but higher estimation accuracy is sometimes required from the market.

One aspect of an exemplary angle detection method of the present invention is an angle detection method for detecting a mechanical angle of a rotation shaft, the angle detection method including: acquiring signals output from three magnetic sensors that detect a change in magnetic flux due to rotation of the rotation shaft as sensor signals, the three sensor signals having a phase difference of 120° in an electrical angle; extracting an intersection point at which two sensor signals among the three sensor signals intersect with each other and a zero-cross point at which each of the three sensor signals intersects with a reference signal level over one mechanical angle cycle; generating a linear function θ(Δx) representing a straight line connecting the intersection point and the zero-cross point adjacent to each other, wherein Δx is a length from a start point of the straight line to an any point on the straight line, and θ is a mechanical angle corresponding to an any point on the straight line; searching, as a maximum error point, a point at which an error between a mechanical angle θ calculated based on the linear function θ(Δx) and a mechanical angle θe acquired from an encoder installed on the rotation shaft is a maximum value among points on the straight line, and acquiring a length from a start point of the straight line to the maximum error point as Δx1; calculating a first curve based on an origin, a vertex, and a first control point among points in a two-axis coordinate system with the Δx as a horizontal axis and the error as a vertical axis, wherein the origin is a point at which the Δx and the error are zero, the vertex is a point at which the Δx is the Δx1 and the error is the maximum value, and the first control point is a point at which the Δx is a value between zero and Δx1 and the error is the maximum value; correcting, based on the first curve, a mechanical angle θ calculated based on the linear function θ(Δx) for a point included between a start point of the straight line and the maximum error point among a plurality of points on the straight line; obtaining a maximum error between a mechanical angle θ corrected in the correcting and a mechanical angle θe as a first maximum error; performing returning to the calculating a predetermined number of times after changing a value of Δx of the first control point in a direction in which the first maximum error decreases; calculating a second curve based on the vertex, an end point, and a second control point among points in the two-axis coordinate system, wherein the end point is a point at which the Δx corresponds to a maximum length Δxm of the straight line and the error is zero, and the second control point is a point at which the Δx is a value between Δx1 and Δxm and the error is the maximum value; correcting, based on the second curve, a mechanical angle θ calculated based on the linear function θ(Δx) for a point included between an end point of the straight line and the maximum error point among a plurality of points on the straight line; obtaining a maximum error between a mechanical angle θ corrected in the correcting and the mechanical angle θe as a second maximum error; performing returning to the calculating a predetermined number of times after changing the value of Δx of the second control point in a direction in which the second maximum error decreases; storing a value of Δx of the first control point at which the first maximum error is minimized and a value of Δx of the second control point at which the second maximum error is minimized as learning values; and correcting the mechanical angle θ based on the learning values.

One aspect of an exemplary angle detection device of the present invention is an angle detection device that detects a mechanical angle of a rotation shaft, the angle detection device including: three magnetic sensors that detect a change in magnetic flux due to rotation of the rotation shaft; and a signal processing unit that processes signals output from the three magnetic sensors. The signal processing unit is configured to execute: acquiring signals output from three sensor signals as sensor signals, the three sensor signals having a phase difference of 120° in an electrical angle; extracting an intersection point at which two sensor signals among the three sensor signals intersect with each other and a zero-cross point at which each of the three sensor signals intersects with a reference signal level over one mechanical angle cycle; generating a linear function θ(Δx) representing a straight line connecting the intersection point and the zero-cross point adjacent to each other, wherein Δx is a length from a start point of the straight line to an any point on the straight line, and θ is a mechanical angle corresponding to an any point on the straight line; searching, as a maximum error point, a point at which an error between a mechanical angle θ calculated based on the linear function θ(Δx) and a mechanical angle θe acquired from an encoder installed on the rotation shaft is a maximum value among points on the straight line, and acquiring a length from a start point of the straight line to the maximum error point as Δx1; calculating a first curve based on an origin, a vertex, and a first control point among points in a two-axis coordinate system with the Δx as a horizontal axis and the error as a vertical axis, wherein the origin is a point at which the Δx and the error are zero, the vertex is a point at which the Δx is the Δx1 and the error is the maximum value, and the first control point is a point at which the Δx is a value between zero and Δx1 and the error is the maximum value; correcting, based on the first curve, a mechanical angle θ calculated based on the linear function θ(Δx) for a point included between a start point of the straight line and the maximum error point among a plurality of points on the straight line; obtaining a maximum error between a mechanical angle θ corrected in the correcting and a mechanical angle θe as a first maximum error; performing returning to the calculating a predetermined number of times after changing a value of Δx of the first control point in a direction in which the first maximum error decreases; calculating a second curve based on the vertex, an end point, and a second control point among points in the two-axis coordinate system, wherein the end point is a point at which the Δx corresponds to a maximum length Δxm of the straight line and the error is zero, and the second control point is a point at which the Δx is a value between Δx1 and Δxm and the error is the maximum value; correcting, based on the second curve, a mechanical angle θ calculated based on the linear function θ(Δx) for a point included between an end point of the straight line and the maximum error point among a plurality of points on the straight line; obtaining a maximum error between a mechanical angle θ corrected in the correcting and the mechanical angle θe as a second maximum error; performing returning to the calculating a predetermined number of times after changing the value of Δx of the second control point in a direction in which the second maximum error decreases; storing a value of Δx of the first control point at which the first maximum error is minimized and a value of Δx of the second control point at which the second maximum error is minimized as learning values; and correcting the mechanical angle θ based on the learning values.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a block diagram schematically illustrating a configuration of an angle detection device according to an embodiment of the present invention;

FIG. 2 is a diagram illustrating an example of waveforms of a U-phase sensor signal Hu, a V-phase sensor signal Hv, and a W-phase sensor signal Hw;

FIG. 3 is an enlarged view of the U-phase sensor signal Hu, the V-phase sensor signal Hv, and the W-phase sensor signal Hw included in one pole pair region illustrated in FIG. 2;

FIG. 4 is a diagram illustrating an example of waveforms of sensor signals Hu, Hv, and Hw including an in-phase signal which is a noise component;

FIG. 5 is a diagram illustrating an example of waveforms of sensor signals Hiu0, Hiv0, and Hiw0 obtained after execution of first correction processing;

FIG. 6 is a diagram illustrating an example of waveforms of sensor signals Hiu1, Hiv1, and Hiw1 obtained after execution of second correction processing;

FIG. 7 is a diagram illustrating an example of waveforms of sensor signals Hiu2, Hiv2, and Hiw2 obtained after execution of third correction processing;

FIG. 8 is a diagram illustrating an example of waveforms of sensor signals Hu′, Hv′, and Hw′ including in-phase signals such as third-order, fifth-order, and seventh-order harmonic signals;

FIG. 9 is a diagram illustrating an example of waveforms of sensor signals Hiu0′, Hiv0′, and Hiw0′ obtained after the first correction processing is performed on the sensor signals Hu′, Hv′, and Hw′;

FIG. 10 is a diagram illustrating an example of waveforms of sensor signals Hiu1′, Hiv1′, and Hiw1′ obtained after the second correction processing is performed on the sensor signals Hiu0′, Hiv0′, and Hiw0′;

FIG. 11 is a diagram illustrating an example of waveforms of sensor signals Hiu2′, Hiv2′, and Hiw2′ obtained after the third correction processing is performed on the sensor signals Hiu1′, Hiv1′, and Hiw1′;

FIG. 12 is a diagram illustrating an experimental result of measuring an error generated between a mechanical angle estimation value θ calculated by Expression (1) and a mechanical angle true value when a pair of sensor magnets is rotated once;

FIG. 13 is a flowchart illustrating learning processing executed as offline processing by a processing unit 21 of the angle detection device 1 according to the present embodiment;

FIG. 14 is a diagram illustrating a method of calculating the mechanical angle estimation value θ[n] corresponding to each sampling point by substituting the digital value Δx[n] of each sampling point obtained by sampling a divided signal W10 corresponding to an i-th segment L10 into the mechanical angle estimation expression of the i-th segment L10;

FIG. 15 is a diagram illustrating an example of a result of calculating an error θerr[n] between a plurality of mechanical angle estimation values θ[n] obtained for the i-th segment L10 and a mechanical angle true value θe[n] obtained from an encoder 200;

FIG. 16 is a diagram illustrating an example of a two-axis coordinate system with Δx on the horizontal axis and an error on the vertical axis, and is an explanatory diagram regarding a method of correcting the mechanical angle estimation value θ based on a Bézier curve;

FIG. 17 is a diagram in which an error between the mechanical angle estimation value θ corrected by the Bézier curve and the mechanical angle true value θe when a first control point P2 in a left coordinate region XL and a second control point P5 in a right coordinate region XR are initial values is plotted together with points on the Bézier curve in a two-axis coordinate system;

FIG. 18 is a diagram illustrating an error between the mechanical angle estimation value θ corrected by the Bézier curve and the mechanical angle true value θe when the first control point P2 in the left coordinate region XL and the second control point P5 in the right coordinate region XR are initial values in association with each digital value Δx[n];

FIG. 19 is a diagram in which an error between the mechanical angle estimation value θ corrected by the Bézier curve and the mechanical angle true value θe when the first control point P2 having the smallest first maximum error in the left coordinate region XL and the second control point P5 having the smallest second maximum error in the right coordinate region XR are used is plotted in a two-axis coordinate system together with points on the Bézier curve; and

FIG. 20 is a diagram illustrating an error between the mechanical angle estimation value θ corrected by the Bézier curve and the mechanical angle true value θe when a first control point P2 having the smallest first maximum error in the left coordinate region XL and the second control point P5 having the smallest second maximum error in the right coordinate region XR are used in association with each digital value Δx[n].

### DETAILED DESCRIPTION

An embodiment of the present invention will be described in detail below with reference to the drawings.

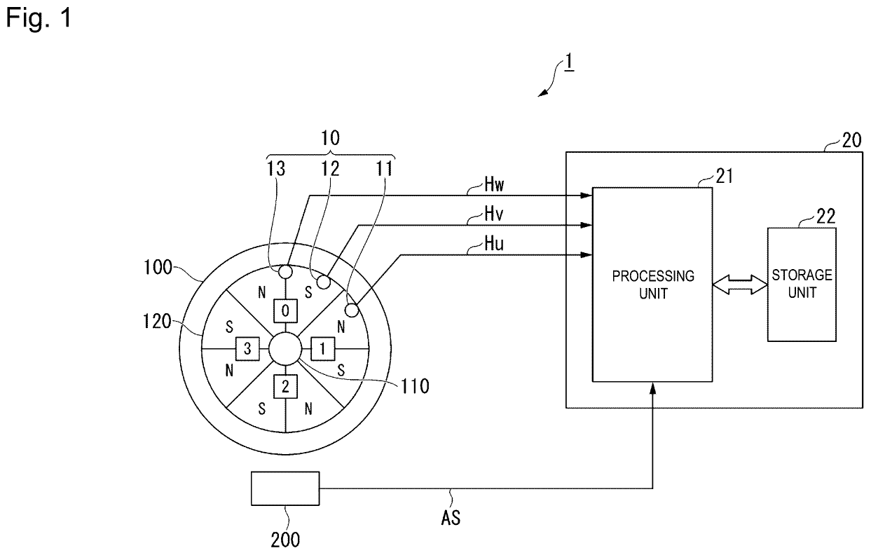

FIG. 1 is a block diagram schematically illustrating the configuration of an angle detection device 1 in one embodiment of the present invention. As illustrated in FIG. 1, the angle detection device 1 is a device that detects a mechanical angle (rotation angle) of a rotor shaft 110 that is a rotation shaft of a motor 100. In the present embodiment, the motor 100 is, for example, an inner rotor type three-phase brushless DC motor. The motor 100 includes a rotor shaft 110 and a sensor magnet 120.

The sensor magnet 120 is a disk-shaped magnet attached to the rotor shaft 110. The sensor magnet 120 rotates in synchronization with the rotor shaft 110. The sensor magnet 120 has P (P is an integer of 1 or more) magnetic pole pairs. In the present embodiment, as an example, the sensor magnet 120 has four magnetic pole pairs. The magnetic pole pair means a pair of an N pole and an S pole. That is, in the present embodiment, the sensor magnet 120 has four pairs of N poles and S poles, and has a total of eight magnetic poles.

The angle detection device 1 includes a sensor group 10 and a signal processing unit 20. Although not illustrated in FIG. 1, a circuit board is mounted on the motor 100, and the sensor group 10 and the signal processing unit 20 are disposed on the circuit board. The sensor magnet 120 is disposed at a position not interfering with the circuit board. The sensor magnet 120 may be disposed inside a housing of the motor 100 or may be disposed outside the housing.

The sensor group 10 includes three magnetic sensors 11, 12, and 13. On the circuit board, the magnetic sensors 11, 12, and 13 face the sensor magnet 120 and are disposed at predetermined intervals along the rotation direction of the sensor magnet 120. In the present embodiment, the magnetic sensors 11, 12, and 13 are disposed at 30° intervals along the rotation direction of the sensor magnet 120. Each of the magnetic sensors 11, 12, and 13 is an analog output type magnetic sensor including a magnetoresistive element such as a Hall element or a linear Hall IC.

When the rotor shaft 110 rotates, the sensor magnet 120 rotates in synchronization with the rotor shaft 110. Each of the three magnetic sensors 11, 12, and 13 detects a change in magnetic flux due to the rotation of the rotor shaft 110, that is, the rotation of the sensor magnet 120, and outputs an analog signal indicating a detection result of the change in magnetic flux to the signal processing unit 20.

One electrical angle cycle of each analog signal output from the magnetic sensors 11, 12, and 13 corresponds to 1/P of one mechanical angle cycle. In the present embodiment, since the number of pole pairs P of the sensor magnet 120 is “4”, one electrical angle cycle of each analog signal corresponds to ¼ of one mechanical angle cycle, that is, 90° in the mechanical angle. The analog signals output from the magnetic sensors 11, 12, and 13 have a phase difference of 120° from one another in electrical angle.

Hereinafter, each analog signal output from the three magnetic sensors 11, 12, and 13 to the signal processing unit 20 is referred to as a sensor signal. In the following description, the sensor signal output from the magnetic sensor 11 may be referred to as a U-phase sensor signal Hu, the sensor signal output from the magnetic sensor 12 may be referred to as a V-phase sensor signal Hv, and the sensor signal output from the magnetic sensor 13 may be referred to as a W-phase sensor signal Hw.

The signal processing unit 20 is a signal processing circuit that processes sensor signals output from the three magnetic sensors 11, 12, and 13. The signal processing unit 20 estimates the mechanical angle of the rotor shaft 110, which is the rotation shaft, based on the U-phase sensor signal Hu output from the magnetic sensor 11, the V-phase sensor signal Hv output from the magnetic sensor 12, and the W-phase sensor signal Hw output from the magnetic sensor 13. The signal processing unit 20 includes a processing unit 21 and a storage unit 22.

The processing unit 21 is a microprocessor such as a microcontroller unit (MCU), for example. The U-phase sensor signal Hu output from the magnetic sensor 11, the V-phase sensor signal Hv output from the magnetic sensor 12, and the W-phase sensor signal Hw output from the magnetic sensor 13 are input to the processing unit 21. The processing unit 21 is communicably connected to the storage unit 22 via a communication bus (not illustrated). The processing unit 21 executes at least the following two processing according to a program stored in the storage unit 22.

The processing unit 21 executes learning processing of acquiring learning data necessary for estimating the mechanical angle of the rotor shaft 110 as offline processing. The offline processing is processing executed before the angle detection device 1 is shipped from a manufacturing factory or before the angle detection device 1 is incorporated in a system on the customer side and is actually operated. In the learning processing, the processing unit 21 acquires learning data based on the sensor signals Hu, Hv, and Hw output from the magnetic sensors 11, 12, and 13 and an output signal AS of an encoder 200 (see FIG. 1). The encoder 200 is installed on the rotor shaft 110 only when the learning processing is performed. The output signal AS of the encoder 200 is a signal indicating a mechanical angle of the rotor shaft 110. The encoder 200 may be either an incremental encoder or an absolute encoder.

In addition, the processing unit 21 executes, as online processing, angle estimation processing of estimating a mechanical angle of the rotor shaft 110 based on the sensor signals Hu, Hv, and Hw output from the magnetic sensors 11, 12, and 13 and learning data obtained by the learning processing. The online processing is processing executed when the angle detection device 1 is incorporated in a system on the customer side and is actually operated.

The storage unit 22 includes a nonvolatile memory that stores programs necessary for causing the processing unit 21 to execute various processing, various setting data, the above-described learning data, and the like, and a volatile memory used as a temporary storage destination of data when the processing unit 21 executes various processing. The nonvolatile memory is, for example, an electrically erasable programmable read-only memory (EEPROM), a flash memory, or the like. The volatile memory is, for example, a random access memory (RAM) or the like.

Hereinafter, before describing learning processing and angle estimation processing executed by the processing unit 21 of the angle detection device 1 configured as described above, a conventional position estimation method will be briefly described in order to facilitate understanding of the present invention. In the following description, the conventional position estimation method may be referred to as a basic patent method. In the following, for convenience of description, the basic patent method will be described using each element illustrated in FIG. 1.

First, learning processing executed by the processing unit 21 in the basic patent method will be described.

The processing unit 21 acquires signals output from the magnetic sensors 11, 12, and 13 as the sensor signals Hu, Hv, and Hw in a state where the sensor magnet 120 is rotated together with the rotor shaft 110. Specifically, an A/D converter is built in the processing unit 21, and the processing unit 21 acquires digital values of the U-phase sensor signal Hu, the V-phase sensor signal Hv, and the W-phase sensor signal Hw by digitally converting each of the U-phase sensor signal Hu, the V-phase sensor signal Hv, and the W-phase sensor signal Hw at a predetermined sampling frequency by the A/D converter.

At the time of execution of the learning processing, the rotor shaft 110 may be rotated by controlling energization of the motor 100 via a motor control device (not illustrated). Alternatively, the rotor shaft 110 may be connected to a rotating machine not illustrated, and the rotating machine may rotate the rotor shaft 110.

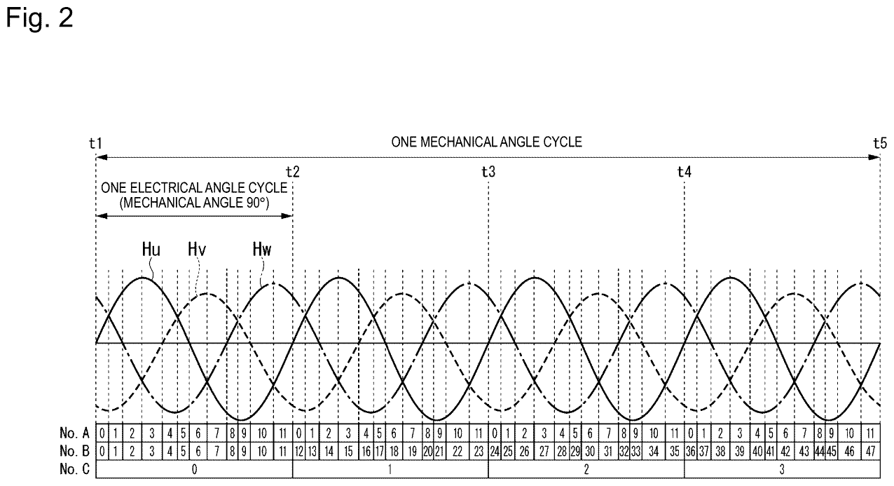

FIG. 2 is a diagram illustrating an example of waveforms of the U-phase sensor signal Hu, the V-phase sensor signal Hv, and the W-phase sensor signal Hw. As illustrated in FIG. 2, one electrical angle cycle of each of the sensor signals Hu, Hv, and Hw corresponds to ¼ of one mechanical angle cycle, that is, 90° in terms of the mechanical angle. In FIG. 2, a period from time t1 to time t5 corresponds to one mechanical angle cycle (360° in mechanical angle). In FIG. 2, the period from time t1 to time t2, the period from time t2 to time t3, the period from time t3 to time t4, and the period from time t4 to time t5 each correspond to 90° in mechanical angle. The sensor signals Hu, Hv, and Hw have a phase difference of 120° in electrical angle with one another.

Based on the digital values of the sensor signals Hu, Hv, and Hw, the processing unit 21 extracts an intersection point at which two sensor signals among the three sensor signals intersect each other and a zero-cross point at which each of the three sensor signals intersects a reference signal level over one mechanical angle cycle. The reference signal level is, for example, a ground level. When the reference signal level is the ground level, the digital value of the reference signal level is “0”.

As illustrated in FIG. 2, the processing unit 21 divides one mechanical angle cycle into four pole pair regions associated with pole pair numbers based on the extraction result of the zero-cross point. In FIG. 2, “No. C” indicates the pole pair number. As illustrated in FIG. 1, pole pair numbers are assigned in advance to the four magnetic pole pairs of the sensor magnet 120. For example, a magnetic pole pair provided in a range of 0° to 90° in mechanical angle is assigned a pole pair number “0”. A magnetic pole pair provided in the range of 90° to 180° in mechanical angle is assigned a pole pair number “1”. A magnetic pole pair provided in the range of 180° to 270° in mechanical angle is assigned a pole pair number “2”. A magnetic pole pair provided in the range of 270° to 360° in mechanical angle is assigned a pole pair number “3”.

For example, in a case where the sensor signal Hu is used as a reference, the processing unit 21 recognizes the zero-cross point obtained at the sampling timing (time t1) at which the mechanical angle is 0° among the zero-cross points of the sensor signal Hu as the start point of the pole pair region associated with the pole pair number “0”. In addition, the processing unit 21 recognizes the zero-cross point obtained at the sampling timing (time t2) at which the mechanical angle is 90° among the zero-cross points of the sensor signal Hu as the end point of the pole pair region associated with the pole pair number “0”. That is, the processing unit 21 determines the interval between the zero-cross point obtained at the time t1 and the zero-cross point obtained at the time t2 as the pole pair region associated with the pole pair number “0”.

The processing unit 21 also recognizes the zero-cross point obtained at the sampling timing (time t2) at which the mechanical angle is 90° among the zero-cross points of the sensor signal Hu as the start point of the pole pair region associated with the pole pair number “1”. Further, the processing unit 21 recognizes the zero-cross point obtained at the sampling timing (time t3) having the mechanical angle of 180° among the zero-cross points of the sensor signal Hu as the end point of the pole pair region associated with the pole pair number “1”. That is, the processing unit 21 determines the interval between the zero-cross point obtained at the time t2 and the zero-cross point obtained at the time t3 as the pole pair region associated with the pole pair number “1”.

The processing unit 21 also recognizes the zero-cross point obtained at the sampling timing (time t3) at which the mechanical angle is 180° among the zero-cross points of the sensor signal Hu as the start point of the pole pair region associated with the pole pair number “2”. In addition, the processing unit 21 recognizes the zero-cross point obtained at the sampling timing (time t4) having the mechanical angle of 270° among the zero-cross points of the sensor signal Hu as the end point of the pole pair region associated with the pole pair number “2”. That is, the processing unit 21 determines the interval between the zero-cross point obtained at the time t3 and the zero-cross point obtained at the time t4 as the pole pair region associated with the pole pair number “2”.

The processing unit 21 also recognizes the zero-cross point obtained at the sampling timing (time t4) at which the mechanical angle is 270° among the zero-cross points of the sensor signal Hu as the start point of the pole pair region associated with the pole pair number “3”. In addition, the processing unit 21 recognizes the zero-cross point obtained at the sampling timing (time t5) having the mechanical angle of 360° among the zero-cross points of the sensor signal Hu as the end point of the pole pair region associated with the pole pair number “3”. That is, the processing unit 21 determines the interval between the zero-cross point obtained at time t4 and the zero-cross point obtained at time t5 as the pole pair region associated with the pole pair number “3”.

As illustrated in FIG. 2, the processing unit 21 divides each of the four pole pair regions into 12 sections associated with section numbers based on the extraction results of the intersection point and the zero-cross point. In FIG. 2, “No. A” indicates a section number associated with each section. As illustrated in FIG. 2, the 12 sections included in each of the four pole pair regions are assigned with the section numbers from “0” to “11”.

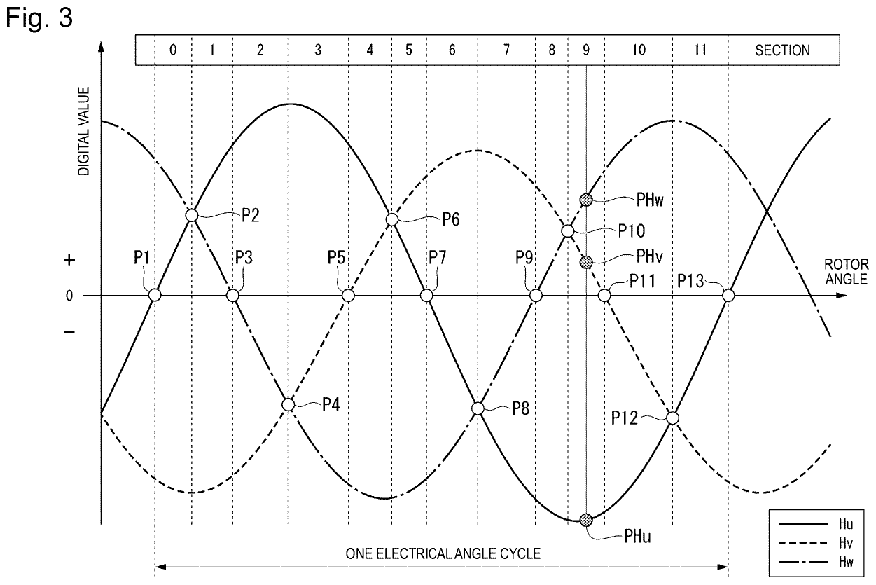

FIG. 3 is an enlarged view of sensor signals Hu, Hv, and Hw included in one pole pair region illustrated in FIG. 2. In FIG. 3, the reference value (reference signal level) of the amplitude is “0”. In FIG. 3, the digital value of amplitude that is a positive value represents a digital value of the magnetic field strength of the N pole, as an example. The digital value of amplitude that is a negative value represents a digital value of the magnetic field strength of the S pole, as an example.

In FIG. 3, points P1, P3, P5, P7, P9, P11, and P13 are zero-cross points extracted from the digital values of the sensor signals Hu, Hv, and Hw included in one pole pair region. In FIG. 3, points P2, P4, P6, P8, P10, and P12 are intersection points extracted from the digital values of the sensor signals Hu, Hv, and Hw included in one pole pair region. As illustrated in FIG. 3, the processing unit 21 determines, as a section, an interval between the zero-cross point and the intersection point adjacent to each other.

The processing unit 21 determines the interval between the zero-cross point P1 and the intersection point P2 as a section assigned with the section number “0”. The processing unit 21 determines the interval between the intersection point P2 and the zero-cross point P3 as a section assigned with the section number “1”. The processing unit 21 determines the interval between the zero-cross point P3 and the intersection point P4 as a section assigned with the section number “2”. The processing unit 21 determines the interval between the intersection point P4 and the zero-cross point P5 as a section assigned with the section number “3”. The processing unit 21 determines the interval between the zero-cross point P5 and the intersection point P6 as a section assigned with the section number “4”. The processing unit 21 determines the interval between the intersection point P6 and the zero-cross point P7 as a section assigned with the section number “5”.

The processing unit 21 determines the interval between the zero-cross point P7 and the intersection point P8 as a section assigned with the section number “6”. The processing unit 21 determines the interval between the intersection point P8 and the zero-cross point P9 as a section assigned with the section number “7”. The processing unit 21 determines the interval between the zero-cross point P9 and the intersection point P10 as a section assigned with the section number “8”. The processing unit 21 determines the interval between the intersection point P10 and the zero-cross point P11 as a section assigned with the section number “9”. The processing unit 21 determines the interval between the zero-cross point P11 and the intersection point P12 as a section assigned with the section number “10”. The processing unit 21 determines the interval between the intersection point P12 and the zero-cross point P13 as the section assigned with the section number “11”.

Note that in the following description, for example, the section assigned with the section number “0” will be referred to as “0th section”, and the section assigned with the section number “11” will be referred to as “11th section”.

As illustrated in FIG. 2, a number continuous over the entire period of one mechanical angle cycle is associated with each section number as a segment number. In FIG. 2, “No. B” indicates a segment number associated with each section number. The segment is a term representing a straight line connecting an intersection point and a zero-cross point adjacent to each other. In other words, a straight line connecting the start point and the end point of each section is called a segment. In FIG. 3, for example, the start point of the 0th section is a zero-cross point P1, and the end point of the 0th section is an intersection point P2. Therefore, the segment corresponding to the 0th section is a straight line connecting the zero-cross point P1 and the intersection point P2. Similarly, in FIG. 3, for example, the start point of the 1st section is an intersection point P2, and the end point of the 1st section is a zero-cross point P3. Therefore, the segment corresponding to the 1st section is a straight line connecting the intersection point P2 and the zero-cross point P3.

As illustrated in FIG. 2, in the pole pair region associated with the pole pair number “0”, the section numbers “0” to “11” are associated with the segment numbers “0” to “11”. In the pole pair region associated with the pole pair number “1”, the section numbers “0” to “11” are associated with the segment numbers “12” to “23”. In the pole pair region associated with the pole pair number “2”, the section numbers “0” to “11” are associated with the segment numbers “24” to “35”. In the pole pair region associated with the pole pair number “3”, the section numbers “0” to “11” are associated with the segment numbers “36” to “47”.

Note that, in the following description, for example, a segment to which the segment number “0” is assigned will be referred to as a “1st segment”, and a segment to which a segment number “11” is assigned will be referred to as a “11th segment”.

The processing unit 21 generates a linear function θ(Δx) representing each segment. Δx is a length (digital value) from the start point of the segment to any point on the segment, and θ is a mechanical angle corresponding to any point on the segment. In FIG. 3, for example, the start point of the segment corresponding to the 0th section is the zero-cross point P1, and the end point of the segment corresponding to the 0th section is the intersection point P2. Similarly, in FIG. 3, for example, the start point of the segment corresponding to the 1st section is the intersection point P2, and the end point of the segment corresponding to the 1st section is the zero-cross point P3.

For example, the linear function θ(Δx) representing the segment is expressed by the following Expression (1). In the following Expression (1), “i” is a segment number and is an integer from 0 to 47. In the following description, the linear function θ(Δx) expressed by the following Expression (1) may be referred to as a mechanical angle estimation expression, and the mechanical angle θ calculated by the following Expression (1) may be referred to as a mechanical angle estimation value.

θ(Δx)=k[i]×Δx+θres[i] (1)

In the above Expression (1), k[i] is a coefficient called a normalization coefficient. In other words, k[i] is a coefficient representing the slope of the i-th segment. The normalization coefficient k[i] is expressed by the following Expression (2). In the following Expression (2), ΔXnorm[i] is a deviation of the digital value between the start point and the end point of the i-th segment. In FIG. 3, for example, ΔXnorm[i] of the segment corresponding to the 0th section is the deviation of the digital value between the zero-cross point P1 and the intersection point P2. Similarly, in FIG. 3, for example, ΔXnorm[i] of the segment corresponding to the 1st section is the deviation of the digital value between the intersection point P2 and the zero-cross point P3.

k[i]=θnorm[i]/ΔXnorm[i] (2)

In the above Expression (2), θnorm[i] is a deviation of the mechanical angle between the start point and the end point of the i-th segment, and is expressed by the following Expression (3). In the following Expression (3), t[i] is the time between the start point and the end point of the i-th segment, t[0] is the time between the start point and the end point of the 0th segment, and t[47] is the time between the start point and the end point of the 47th segment. In FIG. 3, for example, when the segment corresponding to the 0th section is the 0th segment, t[0] is the time between the zero-cross point P1 and the intersection point P2.

θnorm[i]={t[i]/(t[0]+ . . . +t[47])}×360[degM] (3)

In the above Expression (1), θres[i] is a constant called an angle reset value of the i-th segment (an intercept of the linear function θ(Δx)). When the segment number “i” is “0”, the angle reset value θres[i] is expressed by the following Expression (4). When the segment number “i” is any one of “1” to “47”, the angle reset value θres[i] is expressed by the following Expression (5).

θres[i]=0[degM] (4)

θres[i]=Σ(θnorm[i−1]) (5)

By performing the learning processing as described above, the processing unit 21 acquires the correspondence relationship among the pole pair number, the section number, and the segment number, the feature data of each section, and the mechanical angle estimation expression of each segment, and stores the acquired data in the storage unit 22 as learning data. Note that the feature data of each section is a magnitude relationship among the digital values of the sensor signals Hu, Hv, and Hw included in each section, positive and negative signs, and the like. In addition, the normalization coefficient k[i] and the angle reset value θres[i] constituting the mechanical angle estimation expression of each segment are stored in the storage unit 22 as learning data.

Next, angle estimation processing executed by the processing unit 21 in the basic patent method will be described.

The processing unit 21 acquires the sensor signals Hu, Hv, and Hw output from the magnetic sensors 11, 12, and 13. Specifically, the processing unit 21 acquires the digital values of the U-phase sensor signal Hu, the V-phase sensor signal Hv, and the W-phase sensor signal Hw by digitally converting each of the U-phase sensor signal Hu, the V-phase sensor signal Hv, and the W-phase sensor signal Hw at a predetermined sampling frequency by the A/D converter.

Then, the processing unit 21 specifies the current section number and pole pair number based on the digital values of the sensor signals Hu, Hv, and Hw obtained at the current sampling timing. For example, in FIG. 3, it is assumed that a point PHu located on the waveform of the U-phase sensor signal Hu, a point PHv located on the waveform of the V-phase sensor signal Hv, and a point PHw located on the waveform of the W-phase sensor signal Hw are digital values of the sensor signals Hu, Hv, and Hw obtained at the current sampling timing. The processing unit 21 specifies the current section (section number) by collating the feature data such as the magnitude relationship and the positive and negative signs of the digital values of the point PHu, the point PHv, and the point PHw with the feature data of each section included in the learning data stored in the storage unit 22. In the example of FIG. 3, the 9th section is specified as the current section. In the present specification, a method of specifying the pole pair number will not be described. It is assumed that, for example, the pole pair number “2” is specified as the pole pair number at the current sampling timing.

Then, the processing unit 21 specifies the current segment number based on the specified current section number and pole pair number. For example, the processing unit 21 specifies the current segment number by an expression of “segment number=12×pole pair number+section number”. As described above, it is assumed that a section number “9” is specified as the current section number, and a pole pair number “2” is specified as the current pole pair number. In this case, the processing unit 21 specifies the segment number “33” as the current segment number (see FIG. 2).

The processing unit 21 reads the normalization coefficient k[i] and the angle reset value θres[i] corresponding to the specified segment number “i” from the learning data stored in the storage unit 22, and calculates the mechanical angle estimation value θ by the mechanical angle estimation expression represented by the above Expression (1). Here, the digital value of the sensor signal corresponding to the specified segment is used as Δx to be substituted into the mechanical angle estimation expression. For example, as described above, when the segment number “33” is specified as the current segment number, the processing unit 21 reads the normalization coefficient k[33] and the angle reset value θres[33] from the storage unit 22, and substitutes the digital value (see FIG. 3) of the point PHv as Δx into the mechanical angle estimation expression to calculate the mechanical angle estimation value θ at the current sampling timing.

The above is the basic procedure for estimating the mechanical angle in the basic patent method on which the present invention is based.

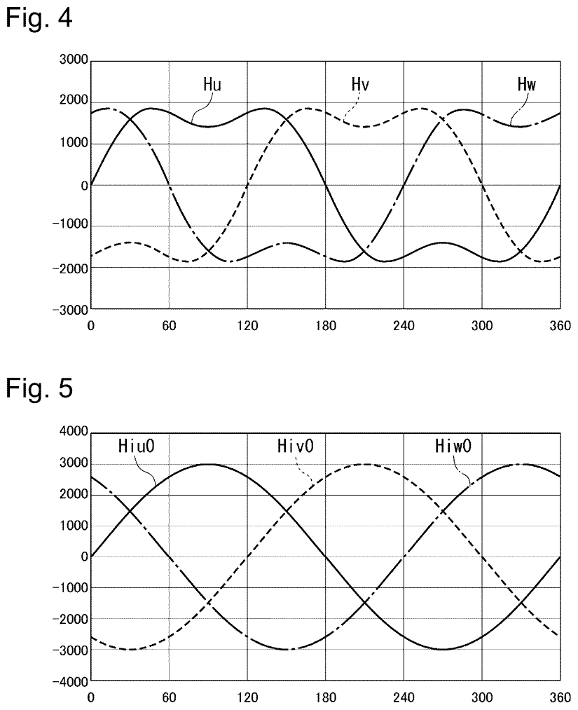

In the basic patent method, correction processing of the sensor signals Hu, Hv, and Hw is performed in order to improve the estimation accuracy of the mechanical angle (accuracy of the mechanical angle estimation value θ). For example, as illustrated in FIG. 2, the amplitude values of the sensor signals Hu, Hv, and Hw do not necessarily coincide with each other. Furthermore, for example, as illustrated in FIG. 4, each of the sensor signals Hu, Hv, and Hw may include an in-phase signal (a DC signal, a third harmonic signal, or the like) that is a noise component. FIG. 4 is a diagram illustrating an example of waveforms of sensor signals Hu, Hv, and Hw including an in-phase signal which is a noise component. In FIG. 4, the vertical axis represents a digital value, and the horizontal axis represents an electrical angle.

Therefore, when acquiring the digital values of the sensor signals Hu, Hv, and Hw at the time of execution of the learning processing and the angle estimation processing, the processing unit 21 in the basic patent method first executes the first correction processing for removing the in-phase signals from the sensor signals Hu, Hv, and Hw based on the following Expressions (6), (7), and (8).

Hiu0=Hu−(Hv+Hw)/2 (6)

Hiv0=Hv−(Hu+Hw)/2 (7)

Hiw0=Hw−(Hu+Hv)/2 (8)

In Expression (6), Hiu0 is a digital value of the U-phase sensor signal obtained by performing the first correction processing on the U-phase sensor signal Hu. In Expression (7), Hiv0 is a digital value of the V-phase sensor signal obtained by performing the first correction processing on the V-phase sensor signal Hv. In Expression (8), Hiw0 is a digital value of the W-phase sensor signal obtained by performing the first correction processing on the W-phase sensor signal Hw. FIG. 5 is a diagram illustrating an example of waveforms of the sensor signals Hiu0, Hiv0, and Hiw0 obtained after execution of the first correction processing. In FIG. 5, the vertical axis represents a digital value, and the horizontal axis represents an electrical angle.

After executing the first correction processing, the processing unit 21 in the basic patent method executes the second correction processing for matching the amplitude values with respect to the sensor signals Hiu0, Hiv0, and Hiw0 based on the following Expressions (9) to (14).

Hiu1(ppn)=au_max(ppn)×Hiu0(ppn)+bu (9)

Hiu1(ppn)=au_min(ppn)×Hiu0(ppn)+bu (10)

Hiv1(ppn)=av_max(ppn)×Hiv0(ppn)+bv (11)

Hiv1(ppn)=av_min(ppn)×Hiv0(ppn)+bv (12)

Hiw1(ppn)=aw_max(ppn)×Hiw0(ppn)+b (13)

Hiw1(ppn)=aw_min(ppn)×Hiw0(ppn)+bw (14)

The processing unit 21 performs the second correction processing on the positive digital value of the U-phase sensor signal Hiu0 by the above Expression (9) using the information stored in the storage unit 22. Furthermore, the processing unit 21 performs the second correction processing on the negative digital value of the U-phase sensor signal Hiu0 by the above Expression (10) using the information stored in the storage unit 22.

The processing unit 21 performs the second correction processing on the positive digital value of the V-phase sensor signal Hiv0 by the above Expression (11) using the information stored in the storage unit 22. Furthermore, the processing unit 21 performs the second correction processing on the negative digital value of the V-phase sensor signal Hiv0 by the above Expression (12) using the information stored in the storage unit 22.

The processing unit 21 performs the second correction processing on the positive digital value of the W-phase sensor signal Hiw0 by the above Expression (13) using the information stored in the storage unit 22. Furthermore, the processing unit 21 performs the second correction processing on the negative digital value of the W-phase sensor signal Hiw0 by the above Expression (14) using the information stored in the storage unit 22.

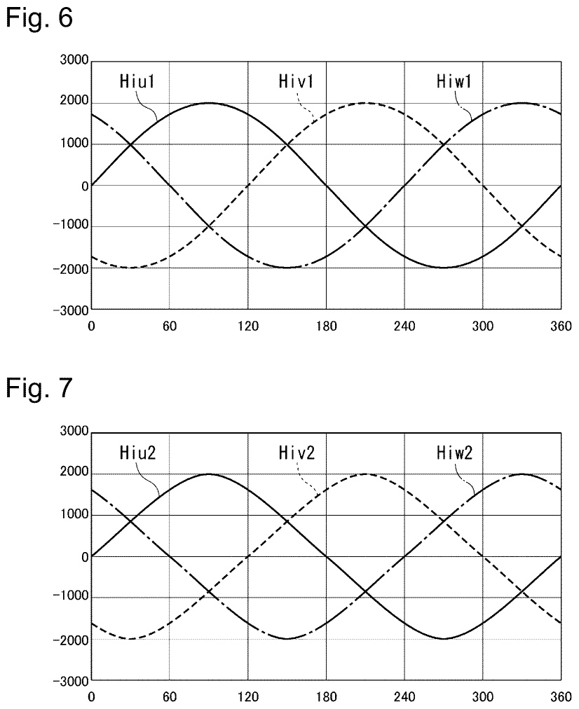

In Expressions (9) and (10), Hiu1 is a digital value of the U-phase sensor signal obtained by performing the second correction processing on the U-phase sensor signal Hiu0. In Expressions (11) and (12), Hiv1 is a digital value of the V-phase sensor signal obtained by performing the second correction processing on the V-phase sensor signal Hiv0. In Expressions (13) and (14), Hiw1 is a digital value of the W-phase sensor signal obtained by performing the second correction processing on the W-phase sensor signal Hiw0. FIG. 6 is a diagram illustrating an example of waveforms of the sensor signals Hiu1, Hiv1, and Hiw1 obtained after execution of the second correction processing. In FIG. 6, the vertical axis represents a digital value, and the horizontal axis represents an electrical angle.

In Expressions (9) to (14), ppn is the pole pair number from 0 to 3. In Expressions (9), (11), and (13), each of au_max(ppn), av_max(ppn), and aw_max(ppn) is a positive-side gain correction value for a positive digital value of one electrical angle cycle corresponding to each magnetic pole pair stored in the storage unit 22 in advance. In Expressions (10), (12), and (14), each of au_min(ppn), av_min(ppn), and aw_min(ppn) is a negative-side gain correction value for a negative-side digital value of one electrical angle cycle corresponding to each magnetic pole pair stored in advance in the storage unit 22. In Expressions (9) to (14), bu, bv, and bw each are the offset correction values of the phases stored in the storage unit 22. Note that au_max(ppn), av_max(ppn), aw_max(ppn), au_min(ppn), av_min(ppn), and aw_min(ppn) each are correction values for each pole pair. Therefore, the number of positive-side gain correction values is 12 (=3 phases×4 pole logarithms). Similarly, the number of negative-side gain correction values is 12.

After executing the second correction processing, the processing unit 21 in the basic patent method executes third correction processing for linearizing a part (divided signal) of the sensor signal corresponding to each segment with respect to the sensor signals Hiu1, Hiv1, and Hiw1. In FIG. 3, for example, when the segment corresponding to the 0th section is the 0th segment, the divided signal corresponding to the 0th segment is a signal of a portion connecting the zero-cross point P1 and the intersection point P2 in the U-phase sensor signal Hu. Similarly, in FIG. 3, for example, when the segment corresponding to the 1st section is the 1st segment, the divided signal corresponding to the 1st segment is a signal of a portion connecting the intersection point P2 and the zero-cross point P3 in the W-phase sensor signal Hw.

The processing unit 21 performs the third correction processing for changing the scale of each sensor signal by using a value stored in advance in the storage unit 22 as a coefficient on the sensor signals Hiu1, Hiv1, and Hiw1. By performing the third correction processing, the substantially S-shaped shape of the divided signal corresponding to each segment can be linearized. Here, the value stored in the storage unit 22 is a value designed in advance. In the third correction processing, calculation processing is performed by a correction formula such as a quadratic function, a cubic function, or a trigonometric function using a value designed in advance.

As an example, the processing unit 21 executes the third correction processing on the sensor signals Hiu1, Hiv1, and Hiw1 based on the following Expressions (15) to (17). In the following Expressions (15) to (17), a and b are coefficients stored in the storage unit 22 in advance.

Hiu2=b×tan (a×Hiu1) (15)

Hiv2=b×tan (a×Hiv1) (16)

Hiw2=b×tan (a×Hiw1) (17)

In Expression (15), Hiu2 is a digital value of the U-phase sensor signal obtained by performing the third correction processing on the U-phase sensor signal Hiu1. In Expression (16), Hiv2 is a digital value of the V-phase sensor signal obtained by performing the third correction processing on the V-phase sensor signal Hiv1. In Expression (17), Hiw2 is a digital value of the W-phase sensor signal obtained by performing the third correction processing on the W-phase sensor signal Hiw1. FIG. 7 is a diagram illustrating an example of waveforms of the sensor signals Hiu2, Hiv2, and Hiw2 obtained after execution of the third correction processing. In FIG. 7, the vertical axis represents a digital value, and the horizontal axis represents an electrical angle.

As described above, in the basic patent method, the in-phase noise included in the sensor signals Hu, Hv, and Hw can be reduced by the first correction processing. In addition, in the basic patent method, the mutual variation of each sensor signal can be corrected by the second correction processing. Here, the mutual variation is, for example, a variation in an amplitude value and an offset component of each sensor signal. Further, in the basic patent method, the curved portion of the waveform of each sensor signal can be linearized by the third correction processing. In particular, since the length of a part (divided signal) of the sensor signal corresponding to the segment is made uniform by performing the second correction processing, it is easy to apply uniform calculation processing to all the divided signals in the third correction processing. Therefore, by performing the second correction processing before the third correction processing, the curved portion of the waveform can be further linearized.

As a result, in the basic patent method, the signal portion (divided signal) necessary for the calculation of the mechanical angle estimation value θ based on the above Expression (1) is further linearized, and the difference between the mechanical angle estimation value θ and the mechanical angle true value (mechanical angle indicated, for example, by an output signal of an encoder attached to the rotor shaft 110) can be reduced, so that highly accurate mechanical angle estimation can be performed.

However, as a result of the verification by the inventor of the present application, in a case where each sensor signal output from the magnetic sensors 11, 12, and 13 includes not only the third harmonic signal but also in-phase signals such as the fifth harmonic signal and the seventh harmonic signal, it has been found that the curved portion (divided signal) of the signal necessary for the calculation of the mechanical angle estimation value θ cannot be linearized even if the first, second, and third correction processing are performed.

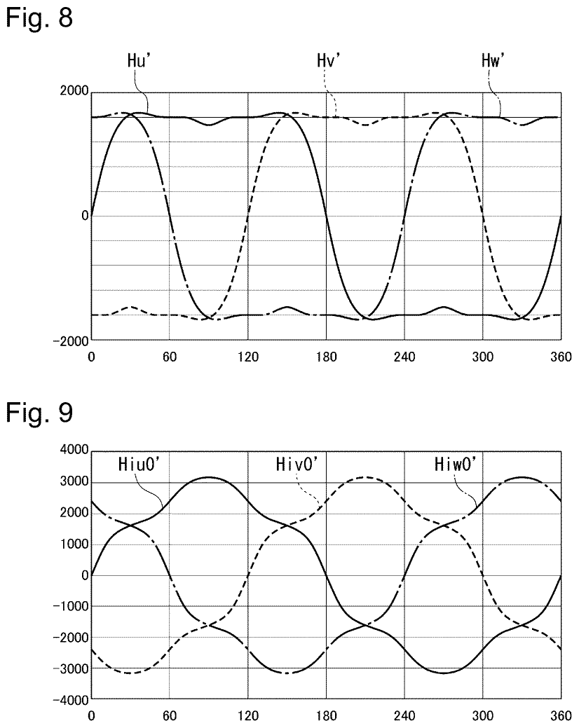

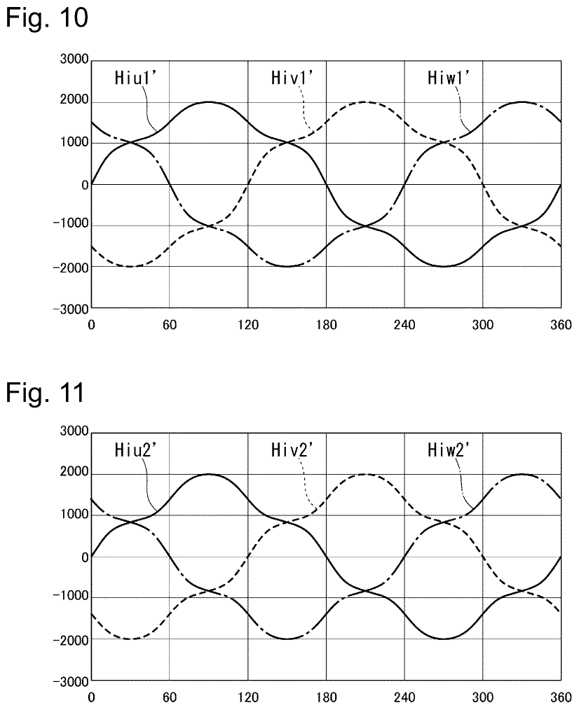

FIG. 8 is a diagram illustrating an example of waveforms of sensor signals Hu′, Hv′, and Hw′ including in-phase signals such as third-order, fifth-order, and seventh-order harmonic signals. FIG. 9 is a diagram illustrating an example of waveforms of sensor signals Hiu0′, Hiv0′, and Hiw0′ obtained after the first correction processing is performed on the sensor signals Hu′, Hv′, and Hw′. FIG. 10 is a diagram illustrating an example of waveforms of sensor signals Hiu1′, Hiv1′, and Hiw1′ obtained after the second correction processing is performed on the sensor signals Hiu0′, Hiv0′, and Hiw0′. FIG. 11 is a diagram illustrating an example of waveforms of sensor signals Hiu2′, Hiv2′, and Hiw2′ obtained after the third correction processing is performed on the sensor signals Hiu1′, Hiv1′, and Hiw1′. In FIGS. 8 to 11, the vertical axis represents a digital value, and the horizontal axis represents an electrical angle.

As illustrated in FIG. 11, when the sensor signals output from the magnetic sensors 11, 12, and 13 include in-phase signals such as third-order, fifth-order, and seventh-order harmonic signals, it can be seen that waveforms of the sensor signals Hiu2′, Hiv2′, and Hiw2′ obtained after the third correction processing are distorted, and the curved portions (divided signals) of signals necessary for calculation of the mechanical angle estimation value θ cannot be linearized. Therefore, in a case where each of the sensor signals output from the magnetic sensors 11, 12, and 13 includes in-phase signals such as third-order, fifth-order, and seventh-order harmonic signals, even if the third correction processing is performed, the estimation accuracy of the mechanical angle (the accuracy of the mechanical angle estimation value θ) based on the above Expression (1) decreases.

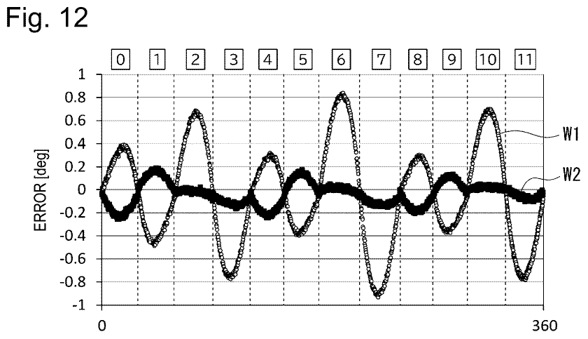

FIG. 12 is a diagram illustrating an experimental result of measuring an error generated between a mechanical angle estimation value θ calculated by Expression (1) and a mechanical angle true value when a pair of sensor magnets is rotated once. In FIG. 12, numbers arranged in the horizontal axis direction represent segment numbers. In this experiment, since one pole pair of sensor magnets is used, only one pole pair region is included in one mechanical angle cycle. That is, one mechanical angle cycle is divided into 12 sections, and segment numbers from “0” to “11” are associated with each section.

In FIG. 12, a waveform W1 indicates a result of measuring an error generated between the mechanical angle estimation value θ and the mechanical angle true value using the sensor signals Hiu1, Hiv1, and Hiw1 obtained after the first and second correction processing are performed on the sensor signals Hu, Hv, and Hw. In FIG. 12, a waveform W2 indicates a result of measuring an error generated between the mechanical angle estimation value θ and the mechanical angle true value using the sensor signals Hiu2, Hiv2, and Hiw2 obtained after the first, second, and third correction processing are performed on the sensor signals Hu, Hv, and Hw.

As illustrated in FIG. 12, for example, in the 2nd, 6th, and 10th segments, the error generated between the mechanical angle estimation value θ and the mechanical angle true value can be reduced to the vicinity of “0” by performing the third correction processing. On the other hand, for example, in the 3rd, 7th, and 11th segments, even if the third correction processing is performed, the error generated between the mechanical angle estimation value θ and the mechanical angle true value cannot be greatly reduced. Furthermore, for example, in the 0th, 1st, 4th, 5th, 8th, and 9th segments, the effect of the third correction processing is too strong, and the sign of the error occurring between the mechanical angle estimation value θ and the mechanical angle true value is inverted. As shown by these experimental results, according to the third correction processing adopted in the basic patent method, it has been found that the error generated between the mechanical angle estimation value θ and the mechanical angle true value greatly varies for each segment due to the difference in the degree of bending of the divided signal for each segment.

An object of the present invention is to solve the technical problem of the basic patent method as described above, to further reduce an angle error generated between the mechanical angle estimation value θ and the mechanical angle true value, and to improve the mechanical angle detection accuracy of the rotation shaft.

Hereinafter, in order to solve the above technical problems, learning processing and angle estimation processing executed by the processing unit 21 of the angle detection device 1 according to the present embodiment will be described.

First, learning processing executed by the processing unit 21 of the angle detection device 1 according to the present embodiment will be described.

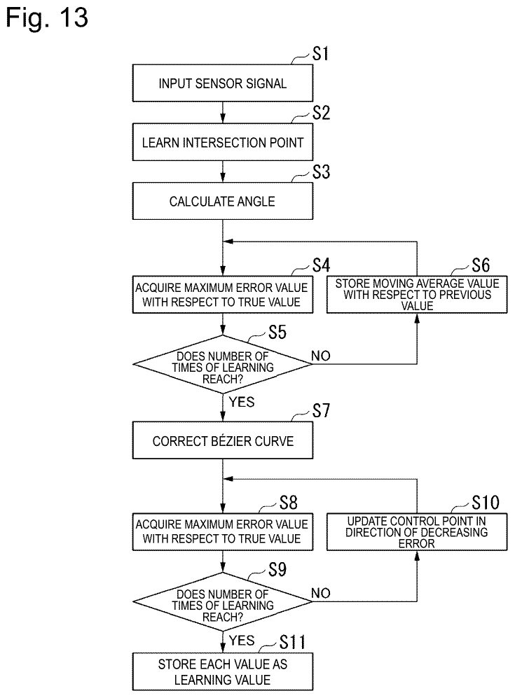

FIG. 13 is a flowchart illustrating learning processing executed as offline processing by the processing unit 21 of the angle detection device 1 according to the present embodiment. The processing unit 21 executes learning processing of acquiring learning data necessary for estimating the mechanical angle of the rotor shaft 110 as offline processing.

As illustrated in FIG. 13, first, a sensor signal is input (step S1). In step S1, the processing unit 21 performs the first process of acquiring signals output from the three magnetic sensors 11, 12, and 13 as sensor signals Hu, Hv, and Hw in a state where the sensor magnet 120 is rotated together with the rotor shaft 110 (first step). Specifically, an A/D converter is built in the processing unit 21, and the processing unit 21 acquires digital values of the U-phase sensor signal Hu, the V-phase sensor signal Hv, and the W-phase sensor signal Hw by digitally converting each of the U-phase sensor signal Hu, the V-phase sensor signal Hv, and the W-phase sensor signal Hw at a predetermined sampling frequency by the A/D converter.

Subsequently, intersection point learning is performed (step S2). In step S2, based on the digital values of the sensor signals Hu, Hv, and Hw, the processing unit 21 performs a second process of extracting an intersection point at which two sensor signals among the three sensor signals intersect with each other and a zero-cross point at which each of the three sensor signals intersect with a reference signal level over one mechanical angle cycle (second step), and performs a third process of generating a linear function θ(Δx) representing a straight line (segment) connecting the intersection points adjacent to each other and the zero-cross point, that is, a mechanical angle estimation expression of each segment (third step).

Since the processing from the first process to the third process is the same as the learning processing in the basic patent method, detailed description thereof will be omitted. Note that, in the present embodiment, the first correction processing, the second correction processing, and the third correction processing in the basic patent method are not performed on the sensor signals Hu, Hv, and Hw acquired in the first process.

By executing the processing from the first process to the third process, the processing unit 21 acquires the correspondence relationship among the pole pair number, the section number, and the segment number, the feature data of each section, and the mechanical angle estimation expression of each segment, and stores the acquired data in the storage unit 22 as learning data. Note that the feature data of each section is a magnitude relationship among the digital values of the sensor signals Hu, Hv, and Hw included in each section, positive and negative signs, and the like. In addition, the normalization coefficient k[i] and the angle reset value θres[i] constituting the mechanical angle estimation expression of each segment are stored in the storage unit 22 as learning data.

Subsequently, the processing unit 21 performs a fourth process of searching, as a maximum error point, a point at which an error between the mechanical angle estimation value θ calculated based on the mechanical angle estimation expression and the mechanical angle θe acquired from the output signal AS of the encoder 200 installed on the rotor shaft 110 is the maximum value among the points on the segment, and acquiring a length from the start point of the segment to the maximum error point as Δx1 (fourth step). Hereinafter, the mechanical angle θe acquired from the encoder 200 may be referred to as a mechanical angle true value.

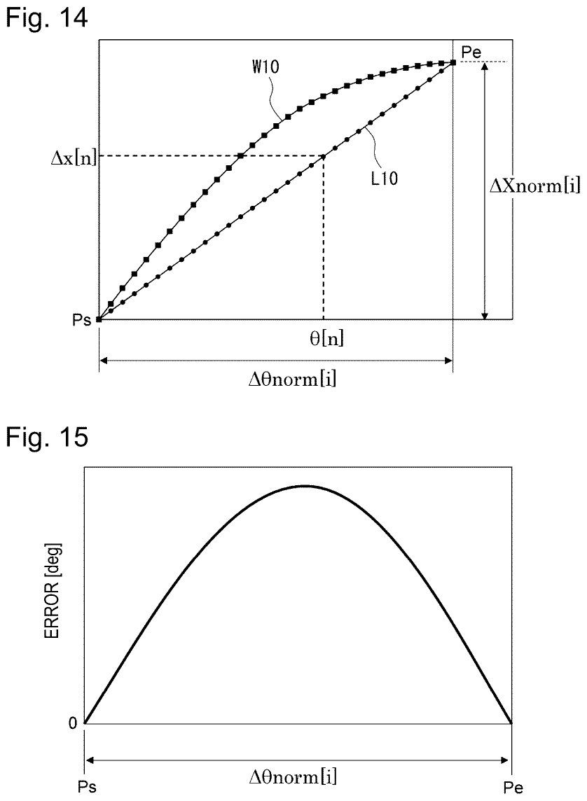

Specifically, as illustrated in FIG. 14, the processing unit 21 calculates the mechanical angle estimation value θ[n] corresponding to each sampling point by substituting the digital value Δx[n] of each sampling point obtained by sampling the divided signal (magnetization waveform) W10 corresponding to the i-th segment L10 into the mechanical angle estimation expression of the i-th segment L10 (step S3). “n” represents a sampling number. That is, Δx[n] is a digital value of the n-th sampling point of the divided signal W10, and the mechanical angle estimation value θ[n] is the mechanical angle estimation value θ corresponding to the n-th sampling point. In FIG. 14, a point Ps is a start point of the i-th segment L10, and a point Pe is an end point of the i-th segment L10.

For example, in a case where the number of sampling points of the divided signal W10 corresponding to the i-th segment L10 is 50, 50 mechanical angle estimation values θ[n] are obtained for the i-th segment L10 by the process of step S3. The processing unit 21 calculates an error θer[n] between each of the plurality of mechanical angle estimation values θ[n] obtained by the process of step S3 and the mechanical angle true value θer[n] obtained from the encoder 200, and acquires the largest error θer[n] among the plurality of calculated errors θer[n] as the maximum error value (step S4). The mechanical angle true value θe[n] is a mechanical angle true value θe obtained at the same sampling timing as the n-th sampling point. The error θer[n] can be calculated by an expression of “θer[n]=θe[n]−θ[n]”. The processing unit 21 stores the maximum error value and the digital value Δx[n] from which the maximum error value has been obtained in the storage unit 22. Hereinafter, the digital value Δx[n] at which the maximum error value is obtained may be referred to as a maximum error acquisition digital value.

FIG. 15 is a diagram illustrating an example of a result of calculating an error θer[n] between a plurality of mechanical angle estimation values θ[n] obtained for the i-th segment L10 and a mechanical angle true value θe[n] obtained from the encoder 200. As illustrated in FIG. 15, since the error θer[n] between the mechanical angle estimation value θ[n] and the mechanical angle true value θe[n] is 0 at the start point and the end point of the i-th segment L10, the curve connecting the plurality of errors θer[n] obtained for the i-th segment L10 is a curve having a mountain shape in which the start point and the end point coincide with each other. Such a curve of the error θer[n] can be regarded as a curve of the magnetization waveform.

When acquiring the maximum error value and the maximum error acquisition digital value of the i-th segment L10 as described above, the processing unit 21 determines whether the number of times of learning has reached a predetermined number (step S5). In the case of “No” in step S5, that is, in the case where the number of times of learning has not reached the predetermined number, the processing unit 21 calculates a moving average value of the current value and the previous value of the maximum error value, stores the calculated moving average value in the storage unit 22 as the previous value of the new maximum error value, calculates a moving average value of the current value and the previous value of the maximum error acquisition digital value, and stores the calculated moving average value in the storage unit 22 as the previous value of the new maximum error acquisition digital value (step S6). After executing the process of step S6, the processing unit 21 returns to the process of step S4. The number of times of learning is incremented each time the process of step S4 is executed.

On the other hand, in a case of “Yes” in step S5, that is, in a case where the number of times of learning has reached the predetermined number of times, the processing unit 21 proceeds to the process of the next step S7. By performing the fourth process including the processes from step S3 to step S6 as described above, the processing unit 21 searches for a point at which the error between the mechanical angle estimation value θ and the mechanical angle true value θe is the maximum value among the points on the i-th segment as the maximum error point, and acquires the length from the start point of the i-th segment to the maximum error point as Δx1. Here, Δx1 is the maximum error acquisition digital value finally stored in the storage unit 22, and the error value at the maximum error point is the maximum error value finally stored in the storage unit 22. The processing unit 21 acquires the maximum error value and the maximum error acquisition digital value for each of the 48 segments by performing the fourth process on all the 48 segments. Hereinafter, the maximum error value of the i-th segment is referred to as θerm[i], and the maximum error acquisition digital value of the i-th segment is referred to as Δx1[i].

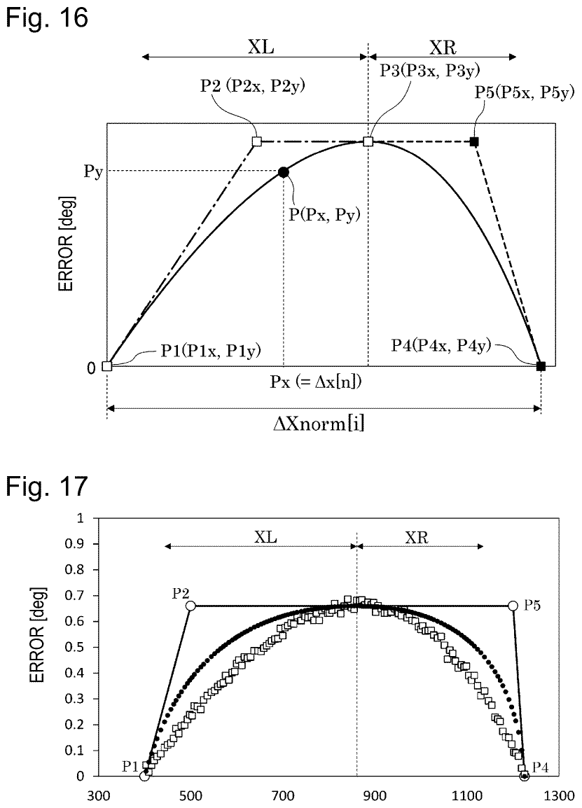

Subsequently, the mechanical angle estimation value θ is corrected based on the Bézier curve (step S7). As one of the processes included in step S7, the processing unit 21 first executes the fifth process of calculating the first curve based on the origin P1, the vertex P3, and the first control point P2 among the points in the two-axis coordinate system with the digital value Δx on the horizontal axis and the error on the vertical axis (fifth step). In the present embodiment, as an example, a case where the first curve is the Bézier curve will be described. FIG. 16 is a diagram illustrating an example of a two-axis coordinate system in which the digital value Δx is on the horizontal axis (X axis) and the error is on the vertical axis (Y axis). The two-axis coordinate system illustrated in FIG. 16 is a coordinate system corresponding to the i-th segment.

In FIG. 16, the origin P1 is a point at which the digital value Δx and the error are 0. Assuming that the coordinates of the origin P1 are (P1x, P1y), a point at which (P1x, P1y)=(0, 0) is satisfied is the origin P1. The vertex P3 is a point at which the digital value Δx is the maximum error acquisition digital value Δx1[i] and the error is the maximum error value θerm[i]. Assuming that coordinates of the vertex P3 are (P3x, P3y), a point at which (P3x, P3y)=(Δx1[i], θerm[i]) is satisfied is the vertex P3. The first control point P2 is a point where the digital value Δx is a value between zero and the maximum error acquisition digital value Δx1[i], and the error is the maximum error value θerm[i]. In the present embodiment, as an example, the initial value of Δx at the first control point P2 is a half value of the maximum error acquisition digital value Δx1[i]. Assuming that the coordinates of the first control point P2 are (P2x, P2y), a point at which (P2x, P2y)=(Δx1[i]/2, θerm[i]) is satisfied is the first control point P2. As illustrated in FIG. 16, among the regions included in the two-axis coordinate system, a region on the left side of the vertex P3 is referred to as a left coordinate region XL, and a region on the right side of the vertex P3 is referred to as a right coordinate region XR.

The processing unit 21 calculates a Bézier curve in the left coordinate region XL based on the origin P1, the vertex P3, and the first control point P2. Hereinafter, the Bézier curve in the left coordinate region XL may be referred to as a first Bézier curve. The coordinates (Px, Py) of the point P located on the first Bézier curve in the left coordinate region XL are expressed by the following Expression (18). Note that, in the following Expression (18), t is resolution.

$$[ Math 1 ]$$

$$P = {( 1 - \frac{1}{t} )}^{2} {P}_{1} + 2 ( 1 - \frac{1}{t} ) \frac{1}{t} {P}_{2} + {\frac{1}{t}}^{2} {P}_{3} \qquad ( 18 )$$

The Y coordinate Py of the point P is expressed by the following Expression (19) based on Expression (18). Since the Y-coordinate P1y of the origin P1 is 0, the following Expression (20) is obtained from Expression (19).

$$[ Math 2 ]$$

$${P}_{y} = {( 1 - \frac{1}{t} )}^{2} {P}_{1 y} + 2 ( 1 - \frac{1}{t} ) \frac{1}{t} {P}_{2 y} + {( \frac{1}{t} )}^{2} {P}_{3 y} \qquad ( 19 )$$

$$[ Math 3 ]$$

$${P}_{y} = {t}^{2} ( {P}_{1 y} - {P}_{3 y} - 2 {P}_{2 y} ) + ( 2 {P}_{2 y} - 2 {P}_{1 y} ) t + {P}_{1 y} \qquad ( 20 )$$

The X coordinate Px of the point P is expressed by the following Expression (21) based on Expression (18). A solution of the resolution t is expressed by the following Expression (22).

$$[ Math 4 ]$$

$${P}_{x} = {( 1 - \frac{1}{t} )}^{2} {P}_{1 x} + 2 ( 1 - \frac{1}{t} ) \frac{1}{t} {P}_{2 x} + {( \frac{1}{t} )}^{2} {P}_{3 x} \qquad ( 21 )$$

$$[ Math 5 ]$$

$$t = \frac{\begin{matrix}\frac{2 ( {P}_{1 x} - {P}_{2 x} )}{{P}_{1 x} - 2 {P}_{2 y} + {P}_{3 x}} \pm \\ \sqrt{{( \frac{2 ( {P}_{2 x} - {P}_{1 x}}{{P}_{1 x} - {P}_{3 x} + 2 {P}_{2 x}} )}^{2} - 4 ( \frac{{P}_{1 x} - {P}_{x}}{{P}_{1 x} + {P}_{3 x} - 2 {P}_{2 x}} )}\end{matrix}}{2} \qquad ( 22 )$$

As described above, since the initial value of Δx at the first control point is a half value of the maximum error acquisition digital value Δx1[i], P3x=2P2x. When P3x=2P2x, the resolution t is expressed by the following Expression (23).

$$[ Math 6 ]$$

$$t = \frac{{P}_{x}}{2 {P}_{2 x}} \qquad ( 23 )$$

By substituting Expressions (22) and (23) into Expression (20), the Y coordinate Py (error corresponding to the digital value Δx[n]) of the point P can be calculated from the X coordinate Px (=Δx[n]) of the point P. Here, as described with reference to FIG. 14, Δx[n] is the digital value Δx of each sampling point obtained by sampling the divided signal corresponding to the i-th segment. The processing unit 21 calculates the first Bézier curve in the left coordinate region XL based on the origin P1, the vertex P3, and the first control point P2 by the above-described calculation method. More precisely, the processing unit 21 calculates the Y coordinate Py of the plurality of points P located on the first Bézier curve from the digital value Δx[n] of each sampling point as an error corresponding to each digital value Δx[n].

Subsequently, as one of the processes included in step S7, the processing unit 21 executes a sixth process of correcting the mechanical angle estimation value θ calculated based on the mechanical angle estimation expression of the i-th segment based on the first Bézier curve for a point included between the start point and the maximum error point of the i-th segment among the plurality of points on the i-th segment (sixth step). Specifically, the processing unit 21 calculates the mechanical angle estimation value θ corrected by the first Bézier curve by substituting the digital value Δx[n] included between the start point (Δx[n]=0) of the i-th segment and the maximum error point (Δx[n]=Δx1[i]) into the following Expression (24). The following Expression (24) is a formula obtained by adding “Err1×Δx[n]” to Expression (1). Err1is a correction value conversion coefficient for converting the digital value Δx[n] into the error obtained by the fifth process (the Y coordinates Py of the plurality of points P located on the first Bézier curve).

θ(Δx[n])=k[i]×Δx[n]+θres[i]+Err1×Δx[n] (24)

The above is the description of step S7, and the processing unit 21 proceeds to step S8 after the end of step S7. In step S8, the processing unit 21 executes a seventh process of acquiring a maximum error between the mechanical angle estimation value θ(Δx[n]) corrected by the above-described sixth process and the mechanical angle true value θe[n] as a first maximum error (seventh step).

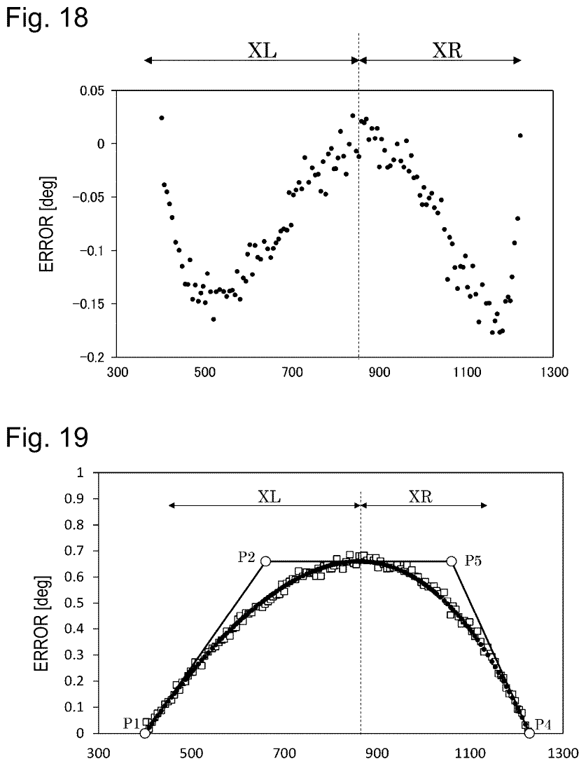

FIG. 17 is a diagram in which an error between the mechanical angle estimation value θ(Δx[n]) corrected by the first Bézier curve and the mechanical angle true value θe[n] when the first control point P2 in the left coordinate region XL is the initial value is plotted in the two-axis coordinate system together with points on the first Bézier curve in the left coordinate region XL. FIG. 18 is a diagram illustrating an error between the mechanical angle estimation value θ(Δx[n]) and the mechanical angle true value θe[n] in association with each digital value Δx[n] by the first Bézier curve when the first control point P2 in the left coordinate region XL is the initial value. As illustrated in FIGS. 17 and 18, when the X coordinate P2x of the first control point P2 is the initial value (=Δx1[i]/2), it can be seen that the error generated between the mechanical angle estimation value θ(Δx[n]) corrected by the first Bézier curve and the mechanical angle true value θe[n] is considerably large. The processing unit 21 acquires, as a first maximum error, the largest error in the left coordinate region XL among errors generated between the mechanical angle estimation value θ(Δx[n]) corrected by the first Bézier curve and the mechanical angle true value θe[n].

Subsequently, the processing unit 21 executes an eighth process in which the value of Δx of the first control point P2 (the X coordinate P2x of the first control point P2) is changed in a direction in which the first maximum error acquired in the left coordinate region XL decreases, and then the processing unit 21 returns to the fifth process a predetermined number of times (eighth step).

Specifically, when acquiring the first maximum error in the left coordinate region XL of the i-th segment as described above, the processing unit 21 determines whether the number of times of learning has reached a predetermined number of times (step S9). In a case where “No” in step S9, that is, in a case where the number of times of learning has not reached the predetermined number of times, the processing unit 21 changes the value of Δx of the first control point P2 (the X coordinate P2x of the first control point P2) in a direction in which the first maximum error decreases, and then returns to step S8 (step S10). The number of times of learning is incremented each time the process of step S8 is executed.

On the other hand, in a case of “Yes” in step S9, that is, in a case where the number of times of learning has reached the predetermined number of times, the processing unit 21 proceeds to the process of the next step S11. By performing the processes from step S7 to step S10 as described above, the processing unit 21 searches for the value of Δx of the first control point P2 (the X coordinate P2x of the first control point P2) at which the first maximum error in the left coordinate region XL of the i-th segment is the smallest. As a search method, for example, a binary search method may be used.

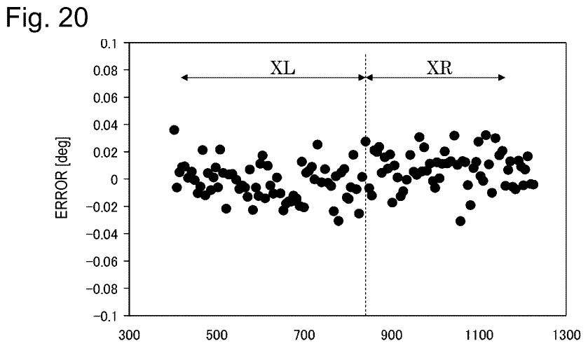

FIG. 19 is a diagram in which the error between the mechanical angle estimation value θ(Δx[n]) corrected by the first Bézier curve and the mechanical angle true value θe[n] when the first control point P2 at which the first maximum error in the left coordinate region XL is the smallest is used is plotted in the two-axis coordinate system together with the points on the first Bézier curve in the left coordinate region XL. FIG. 20 is a diagram illustrating an error between the mechanical angle estimation value θ(Δx[n]) corrected by the first Bézier curve and the mechanical angle true value θe[n] when the first control point P2 having the smallest first maximum error in the left coordinate region XL is used, in association with each digital value Δx[n]. As illustrated in FIGS. 19 and 20, when the first control point P2 at which the first maximum error in the left coordinate region XL of the i-th segment is the smallest is obtained, it can be seen that the error occurring between the mechanical angle estimation value θ(Δx[n]) corrected by the first Bézier curve and the mechanical angle true value θe[n] 0 as much as possible.

Although the left coordinate region XL of the two-axis coordinate system corresponding to the i-th segment has been described above, the same processes as described above are performed also for the right coordinate region XR of the two-axis coordinate system. That is, the processing unit 21 executes a ninth process of calculating a second curve of the right coordinate region XR based on the vertex P3, the end point P4, and the second control point P5 located in the right coordinate region XR among the points in the two-axis coordinate system with the digital value Δx on the horizontal axis and the error on the vertical axis (ninth step). In the present embodiment, as an example, a case where the second curve is a Bézier curve will be described.

In FIG. 16, the end point P4 is a point at which the digital value Δx corresponds to the maximum length Δxm (=ΔXnorm[i]) of the i-th segment and the error is 0. Assuming that the coordinates of the end point P4 are (P4x, P4y), a point at which (P4x, P4y)=(ΔXnorm[i], 0) is satisfied is the end point P4. The second control point P5 is a point that the digital value Δx is a value between the maximum error acquisition digital value Δx1[i] and the maximum length Δxm (=ΔXnorm[i]) of the i-th segment, and the error is the maximum error value θerm[i]. In the present embodiment, as an example, the initial value of Δx at the second control point P5 is a half value of the difference between the maximum error acquisition digital value Δx1[i] and the maximum length Δxm (=ΔXnorm[i]) of the i-th segment. Assuming that the coordinates of the second control point P5 are (P5x, P5y), a point at which (P5x, P5y)={(ΔXnorm[i]−Δx1[i])/2, θerm[i]} is established is the second control point P5.

The processing unit 21 calculates a Bézier curve in the right coordinate region XR based on the vertex P3, the end point P4, and the second control point P5 as described above. Hereinafter, the Bézier curve in the right coordinate region XR may be referred to as a second Bézier curve. Since the method of calculating the second Bézier curve in the right coordinate region XR is similar to the method of calculating the first Bézier curve in the left coordinate region XL, a detailed description thereof will be omitted. The processing unit 21 calculates the second Bézier curve in the right coordinate region XR based on the vertex P3, the end point P4, and the second control point P5 by a calculation method similar to that of the first Bézier curve. More precisely, the processing unit 21 calculates the Y coordinate Py of the plurality of points P located on the second Bézier curve from the digital value Δx[n] of each sampling point as an error corresponding to each digital value Δx[n].

Subsequently, the processing unit 21 executes a tenth process of correcting the mechanical angle estimation value θ calculated based on the mechanical angle estimation expression of the i-th segment based on the second Bézier curve for a point included between the end point and the maximum error point of the i-th segment among the plurality of points on the i-th segment (tenth step). Specifically, the processing unit 21 calculates the mechanical angle estimation value θ corrected by the second Bézier curve by substituting the digital value Δx[n] included between the end point (Δx[n]=ΔXnorm[i]) of the i-th segment and the maximum error point (Δx[n]=Δx1[i]) into the following Expression (25). The following Expression (25) is a formula obtained by adding “Err2×Δx[n]” to Expression (1). Err2 is a correction value conversion coefficient for converting the digital value Δx[n] into the error obtained by the ninth process (the Y coordinate Py of the plurality of points P located on the second Bézier curve).

θ(Δx[n])=k[i]×Δx[n]+θres[i]+Err2×Δx[n] (25)

The processing unit 21 executes an eleventh process of acquiring the maximum error between the mechanical angle estimation value θ(Δx[n]) corrected by the tenth process and the mechanical angle true value θe[n] as the second maximum error (eleventh step).

FIG. 17 is a diagram in which an error between the mechanical angle estimation value θ(Δx[n]) corrected by the second Bézier curve and the mechanical angle true value θe[n] when the second control point P5 in the right coordinate region XR is the initial value is plotted in the two-axis coordinate system together with the point on the second Bézier curve in the right coordinate region XR. FIG. 18 is a diagram illustrating an error between the mechanical angle estimation value θ(Δx[n]) corrected by the second Bézier curve and the mechanical angle true value θe[n] when the second control point P5 in the right coordinate region XR is the initial value in association with each digital value Δx[n]. As illustrated in FIGS. 17 and 18, when the X coordinate P5x of the second control point P5 is the initial value, it can be seen that the error generated between the mechanical angle estimation value θ(Δx[n]) corrected by the second Bézier curve and the mechanical angle true value θe[n] is considerably large. The processing unit 21 acquires, as a second maximum error, the largest error in the right coordinate region XR among errors generated between the mechanical angle estimation value θ(Δx[n]) corrected by the second Bézier curve and the mechanical angle true value θe[n].

Subsequently, the processing unit 21 executes a twelfth process in which the value of Δx of the second control point P5 (the X coordinate P5x of the second control point P5) is changed in a direction in which the second maximum error acquired in the right coordinate region XR decreases, and then the processing unit 21 returns to the ninth process a predetermined number of times (twelfth step).

Specifically, when acquiring the second maximum error in the right coordinate region XR of the i-th segment as described above, the processing unit 21 determines whether the number of times of learning has reached a predetermined number of times (step S9). In a case where “No” in step S9, that is, in a case where the number of times of learning has not reached the predetermined number, the processing unit 21 changes the value of Δx of the second control point P5 (the X coordinate P5x of the second control point P5) in a direction in which the second maximum error decreases, and then returns to step S8 (step S10). The number of times of learning is incremented each time the process of step S8 is executed.

On the other hand, in a case of “Yes” in step S9, that is, in a case where the number of times of learning has reached the predetermined number of times, the processing unit 21 proceeds to the process of the next step S11. By performing the processes from step S7 to step S10 as described above, the processing unit 21 searches for the value of Δx of the second control point P5 (the X coordinate P5x of the second control point P5) at which the second maximum error in the right coordinate region XR of the i-th segment is the smallest. As a search method, for example, a binary search method may be used.

FIG. 19 is a diagram in which an error between the mechanical angle estimation value θ(Δx[n]) corrected by the second Bézier curve and the mechanical angle true value θe[n] when the second control point P5 at which the second maximum error in the right coordinate region XR is the smallest is plotted in the two-axis coordinate system together with the points on the second Bézier curve in the right coordinate region XR. FIG. 20 is a diagram illustrating an error between the mechanical angle estimation value θ(Δx[n]) corrected by the second Bézier curve and the mechanical angle true value θe[n] when the second control point P5 at which the second maximum error in the right coordinate region XR is the smallest is used in association with each digital value Δx[n]. As illustrated in FIGS. 19 and 20, when the second control point P5 at which the second maximum error in the right coordinate region XR of the i-th segment is the smallest is obtained, it can be seen that the error occurring between the mechanical angle estimation value θ(Δx[n]) corrected by the second Bézier curve and the mechanical angle true value θe[n] approaches as close as possible to 0.

When the first control point P2 having the smallest first maximum error in the left coordinate region XL and the second control point P5 having the smallest second maximum error in the right coordinate region XR are obtained for the i-th segment by the above processes, the processing unit 21 proceeds to the process of the next step S11. In step S11, the processing unit 21 executes a thirteenth process of storing the value of Δx of the first control point P2 having the smallest first maximum error and the value of Δx of the second control point P5 having the smallest second maximum error in the storage unit 22 as learning values (thirteenth step).

The processing unit 21 performs the processes from the fifth process to the thirteenth process on all the 48 segments to acquire the value of Δx at the first control point P2 at which the first maximum error is smallest and the value of Δx at the second control point P5 at which the second maximum error is smallest for each of the 48 segments. As a result, at the end of the learning processing, for each of the 48 segments, the value of Δx at the first control point P2 at which the first maximum error is smallest and the value of Δx at the second control point P5 at which the second maximum error is smallest are stored in the storage unit 22 as learning values.

Next, angle estimation processing executed by the processing unit 21 in the present embodiment will be described.

The processing unit 21 acquires the sensor signals Hu, Hv, and Hw output from the magnetic sensors 11, 12, and 13. Specifically, the processing unit 21 acquires the digital values of the U-phase sensor signal Hu, the V-phase sensor signal Hv, and the W-phase sensor signal Hw by digitally converting each of the U-phase sensor signal Hu, the V-phase sensor signal Hv, and the W-phase sensor signal Hw at a predetermined sampling frequency by the A/D converter.

Then, the processing unit 21 specifies the current section number and pole pair number based on the digital values of the sensor signals Hu, Hv, and Hw obtained at the current sampling timing. For example, in FIG. 3, it is assumed that a point PHu located on the waveform of the U-phase sensor signal Hu, a point PHv located on the waveform of the V-phase sensor signal Hv, and a point PHw located on the waveform of the W-phase sensor signal Hw are digital values of the sensor signals Hu, Hv, and Hw obtained at the current sampling timing. The processing unit 21 specifies the current section (section number) by collating the feature data such as the magnitude relationship and the positive and negative signs of the digital values of the point PHu, the point PHv, and the point PHw with the feature data of each section included in the learning data stored in the storage unit 22. In the example of FIG. 3, the 9th section is specified as the current section. In addition, it is assumed that, for example, the pole pair number “2” is specified as the pole pair number at the current sampling timing.

Then, the processing unit 21 specifies the current segment number based on the specified current section number and pole pair number. For example, the processing unit 21 specifies the current segment number by an expression of “segment number=12×pole pair number+section number”. As described above, it is assumed that a section number “9” is specified as the current section number, and a pole pair number “2” is specified as the current pole pair number. In this case, the processing unit 21 specifies the segment number “33” as the current segment number (see FIG. 2).

Then, the processing unit 22 reads the normalization coefficient k[i] and the angle reset value θres[i] corresponding to the specified segment number “i” from the learning data stored in the storage unit 22, and calculates the mechanical angle estimation value θ by the mechanical angle estimation expression represented by Expression (1). Here, the digital value of the sensor signal corresponding to the specified segment is used as Δx to be substituted into the mechanical angle estimation expression. For example, as described above, when the segment number “33” is specified as the current segment number, the processing unit 21 reads the normalization coefficient k and the angle reset value θres from the storage unit 22, and substitutes the digital value (see FIG. 3) of the point PHv in Expression (1) as Δx to calculate the mechanical angle estimation value θ at the current sampling timing.

Then, the processing unit 21 executes a fourteenth process of correcting the mechanical angle estimation value θ based on the learning value stored in the storage unit 22 (fourteenth step). Specifically, after calculating the mechanical angle estimation value θ as described above, the processing unit 21 reads the learning value corresponding to the identified segment number “i”, that is, the value of Δx of the first control point P2 having the smallest first maximum error and the value of Δx of the second control point P5 having the smallest second maximum error from the storage unit 22, and corrects the mechanical angle estimation value θ by the first Bézier curve and the second Bézier curve based on the coordinates of the origin P1, the vertex P3, and the end point P4 in addition to the first control point P2 and the second control point P5. The mechanical angle estimation value θ obtained after the correction using such a Bézier curve has an error with the mechanical angle true value θe that is an extremely accurate value close to zero as much as possible.

As described above, in the basic patent method, in a case where the sensor signals output from the magnetic sensors 11, 12, and 13 include in-phase signals such as third-order, fifth-order, and seventh-order harmonic signals, even if the first, second, and third correction processing are performed, the estimation accuracy of the mechanical angle (the accuracy of the mechanical angle estimation value θ) based on the above Expression (1) decreases. In this regard, according to the present embodiment, even if the first, second, and third correction processing are not performed on the sensor signals output from the magnetic sensors 11, 12, and 13, it is possible to obtain the mechanical angle estimation value θ with extremely high accuracy in which the error from the mechanical angle true value θe is as close as possible to 0.

In addition, according to the third correction processing adopted in the basic patent method, the error generated between the mechanical angle estimation value θ and the mechanical angle true value θe greatly varies for each segment due to the difference in the degree of bending of the divided signal for each segment. In this regard, according to the present embodiment, even if the degree of bending of the divided signal is different for each segment, it is possible to obtain the mechanical angle estimation value θ with extremely high accuracy in which the error from the mechanical angle true value θe is as close as possible to zero for each segment.

According to the present embodiment, it is possible to solve the technical problem of the basic patent method as described above to further reduce an angle error generated between the mechanical angle estimation value θ and the mechanical angle true value θe, so as to improve the mechanical angle detection accuracy of the rotation shaft.

The present invention is not limited to the above embodiments, and the configurations described in the present description can be appropriately combined within a range not conflicting with one another.

For example, in the above embodiment, the case where the first curve and the second curve are Bézier curves has been exemplified, but the first curve and the second curve may be B-spline curves. Alternatively, the first curve and the second curve may be curves that can be calculated from at least three points.

In the above embodiment, the case where the sensor magnet 120 is used as a magnet for position detection, that is, a magnet that rotates in synchronization with the rotor shaft 110 of the motor 100 has been exemplified. However, the rotor magnet attached to the rotor of the motor 100 may be used as a magnet for position detection. The rotor magnet is also a magnet that rotates in synchronization with the rotor shaft 110, and has a plurality of magnetic pole pairs.

In the above embodiment, the case where the sensor group 10 includes the three magnetic sensors 11, 12, and 13 has been exemplified, but the number of magnetic sensors is not limited to three and may be N (N is a multiple of 3). Further, in the above embodiment, the case where the sensor magnet 120 has four magnetic pole pairs has been exemplified, but the number of pole pairs of the sensor magnet 120 is not limited to four. Similarly, when the rotor magnet is used as a magnet for position detection, the number of pole pairs of the rotor magnet is not limited to four.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An angle detection method for detecting a mechanical angle of a rotation shaft, the angle detection method comprising:
acquiring signals output from three magnetic sensors that detect a change in magnetic flux due to rotation of the rotation shaft as sensor signals, the three sensor signals having a phase difference of 120° in an electrical angle;
extracting an intersection point at which two sensor signals among the three sensor signals intersect with each other and a zero-cross point at which each of the three sensor signals intersects with a reference signal level over one mechanical angle cycle;
generating a linear function θ(Δx) representing a straight line connecting the intersection point and the zero-cross point adjacent to each other, where Δx is a length from a start point of the straight line to an any point on the straight line, and θ is a mechanical angle corresponding to an any point on the straight line;
searching for, as a maximum error point, a point at which an error between a mechanical angle θ calculated based on the linear function θ(Δx) and a mechanical angle θe acquired from an encoder installed on the rotation shaft is a maximum value among points on the straight line, and acquiring a length from a start point of the straight line to the maximum error point as Δx1;
calculating a first curve based on an origin, a vertex, and a first control point among points in a two-axis coordinate system with the Δx as a horizontal axis and the error as a vertical axis, where the origin is a point at which the Δx and the error are zero, the vertex is a point at which the Δx is the Δx1 and the error is the maximum value, and the first control point is a point at which the Δx is a value between zero and Δx1 and the error is the maximum value;
correcting, based on the first curve, a mechanical angle θ calculated based on the linear function θ(Δx) for a point included between a start point of the straight line and the maximum error point among a plurality of points on the straight line;
obtaining a maximum error between a mechanical angle θ corrected in the correcting and a mechanical angle θe as a first maximum error;
performing returning to the calculating a predetermined number of times after changing a value of Δx of the first control point in a direction in which the first maximum error decreases;
calculating a second curve based on the vertex, an end point, and a second control point among points in the two-axis coordinate system, where the end point is a point at which the Δx corresponds to a maximum length Δxm of the straight line and the error is zero, and the second control point is a point at which the Δx is a value between Δx1 and Δxm and the error is the maximum value;
correcting, based on the second curve, a mechanical angle θ calculated based on the linear function θ(Δx) for a point included between an end point of the straight line and the maximum error point among a plurality of points on the straight line;
obtaining a maximum error between a mechanical angle θ corrected in the correcting and the mechanical angle θe as a second maximum error;
performing returning to the calculating a predetermined number of times after changing the value of Δx of the second control point in a direction in which the second maximum error decreases;
storing a value of Δx of the first control point at which the first maximum error is minimized and a value of Δx of the second control point at which the second maximum error is minimized as learning values; and
correcting the mechanical angle θ based on the learning values.

2. The angle detection method according to claim 1, wherein the first curve and the second curve are Bézier curves or B-spline curves.

3. The angle detection method according to claim 1, wherein an initial value of Δx at the first control point is a half value of the Δx1.

4. The angle detection method according to claim 1, wherein an initial value of Δx of the second control point is a half value of a difference between the Δx1 and the Δxm.

5. An angle detection device that detects a mechanical angle of a rotation shaft, the angle detection device comprising:
three magnetic sensors configured to detect a change in magnetic flux due to rotation of the rotation shaft; and
a signal processing unit configured to process signals output from the three magnetic sensors,
wherein the signal processing unit is configured to execute:
acquiring signals output from three sensor signals as sensor signals, the three sensor signals having a phase difference of 120° in an electrical angle;
extracting an intersection point at which two sensor signals among the three sensor signals intersect with each other and a zero-cross point at which each of the three sensor signals intersects with a reference signal level over one mechanical angle cycle;
generating a linear function θ(Δx) representing a straight line connecting the intersection point and the zero-cross point adjacent to each other, where Δx is a length from a start point of the straight line to an any point on the straight line, and θ is a mechanical angle corresponding to an any point on the straight line;
searching for, as a maximum error point, a point at which an error between a mechanical angle θ calculated based on the linear function θ(Δx) and a mechanical angle θe acquired from an encoder installed on the rotation shaft is a maximum value among points on the straight line, and acquiring a length from a start point of the straight line to the maximum error point as Δx1;
calculating a first curve based on an origin, a vertex, and a first control point among points in a two-axis coordinate system with the Δx as a horizontal axis and the error as a vertical axis, where the origin is a point at which the Δx and the error are zero, the vertex is a point at which the Δx is the Δx1 and the error is the maximum value, and the first control point is a point at which the Δx is a value between zero and Δx1 and the error is the maximum value;
correcting, based on the first curve, a mechanical angle θ calculated based on the linear function θ(Δx) for a point included between a start point of the straight line and the maximum error point among a plurality of points on the straight line;
obtaining a maximum error between a mechanical angle θ corrected in the correcting and a mechanical angle θe as a first maximum error;
performing returning to the calculating a predetermined number of times after changing a value of Δx of the first control point in a direction in which the first maximum error decreases;
calculating a second curve based on the vertex, an end point, and a second control point among points in the two-axis coordinate system, where the end point is a point at which the Δx corresponds to a maximum length Δxm of the straight line and the error is zero, and the second control point is a point at which the Δx is a value between Δx1 and Δxm and the error is the maximum value;
correcting, based on the second curve, a mechanical angle θ calculated based on the linear function θ(Δx) for a point included between an end point of the straight line and the maximum error point among a plurality of points on the straight line;
obtaining a maximum error between a mechanical angle θ corrected in the correcting and the mechanical angle θe as a second maximum error;
performing returning to the calculating a predetermined number of times after changing the value of Δx of the second control point in a direction in which the second maximum error decreases;
storing a value of Δx of the first control point at which the first maximum error is minimized and a value of Δx of the second control point at which the second maximum error is minimized as learning values; and
correcting the mechanical angle θ based on the learning values.

6. The angle detection device according to claim 5, wherein the first curve and the second curve are Bézier curves or B-spline curves.

7. The angle detection device according to claim 5, wherein an initial value of Δx at the first control point is a half value of the Δx1.

8. The angle detection device according to claim 5, wherein an initial value of Δx of the second control point is a half value of a difference between the Δx1 and the Δxm.
